(19) United States
(12) Patent Application Publication
(10) Pub. No.: US 2016/0107728 A1
(43) Pub. Date: Apr. 21, 2016

(54) THREADLESS FAIRLEAD

(71) Applicant: Vincent Brenner, South Haven, MI (US)

(72) Inventor: Vincent Brenner, South Haven, MI (US)

(21) Appl. No.: 14/978,717

(22) Filed: Dec. 22, 2015

Related U.S. Application Data
(63) Continuation-in-part of application No. 13/857,116, filed on Apr. 4, 2013, now abandoned.

(51) Int. Cl. B63B 21/10; B66D 1/36

(52) U.S. Cl. CPC B63B 21/10; B66D 1/36

(57) ABSTRACT

A threadless fairlead assembly for a sailing vessel is provided, in which the C-shaped fairlead, or the double C-shaped body fairlead body has a channel which passes from the outside of the body to the aperture and is closed by a latch pin, this configuration allows a line to pass in and out of the assembly while remaining relatively parallel to the centerline of the aperture.

### RELATED APPLICATIONS

This patent application is a continuation in part application, claiming priority from U.S. patent application Ser. No. 13/857,116 titled Threadless Fairlead, filed on Apr. 4, 2013, which is pending.

### BACKGROUND OF THE INVENTION

In general, a “fairlead” is a device used on marine vessels to lead and position ropes, lines or running rigging; for example, on a sailing vessel, the lines which are used to control the position and shape of a sail. Fairleads are employed to prevent extraneous binding, friction, and/or chafe on the lines or running rigging.

A conventional fairlead generally comprises of a closed block which is mounted to a surface, the block has a through aperture passing perpendicular to the main face of the block which is used to capture the line. In order to capture a line with a conventional fairlead, the free end of the rope must be threaded and drawn through the block's aperture. “Threadless” fairleads are generally of an open configuration; the body not only has the through aperture but also has a channel which is set with its axis at an angle to the main axis of the aperture. The channel creates a free gap from the outside of the block to the inside aperture and allows for the release or capture of the line at any point along its length. As the channel is set at an angle to the main aperture, the line must be skewed to match this axis in order for the member to pass through the channel and locate in the aperture or of the reverse. After the line passes through the channel and enters the aperture, it then can assume the center line of the aperture to work within the fairlead body. This engagement or disengagement of the line via skewing can be particularly challenging and time consuming when the line is under tension or load.

One type of threadless fairlead currently available in the market is shown in U.S. Pat. No. D564,342 and is shown as prior art in FIG. 2. Generally, the design incorporates a base 80 with two inverted, “j” shaped hooks 93 with each one of their respective ends affixed at locations on the base 80; the hooks are bent, parallel and the free ends point to each other; the curvature of the hooks are aligned to form an aperture. The hooks are offset and have a projected channel between them; wherein a rope would be skewed for insertion or extraction relative to the aperture.

There is a need for a threadless fairlead, with the fairlead having improvements to allow for the expeditious engagement or disengagement of the line relative to the device, without having to skew the line in situations where the line is under tension or load.

There is also a need for a threadless fairlead having an assembly including an open main body with aperture and a traversing latch pin with pull to provide closure. The fairlead main body is C-shaped which affords a rigid, fixed position for the aperture; the channel runs parallel to the base and opens to one side of the body. The channel and aperture have a width which is slightly larger than the largest diameter line that the fairlead can accept. A traversing latch pin moves vertically within a cavity in the body, the centerline of which is offset from the center of the aperture and runs perpendicular to it. This latch pin so provides the means to close and open the aperture. The latch pin seats in a cavity in the bottom of the channel at closure of the aperture. A pull pin extends from the latch pin and exits through the top of the body. The pull is secured to the latch pin and moves directly in relation, thus providing the means to actuate the mechanism. The latch pin may be spring loaded to force the channel to close but may also be free or magnetically latched.

There is also a need for a threadless fairlead that greatly improves the functionality of the assembly in comparison with the prior art, especially in terms of allowing the sailor to easily couple or release the line and fairlead without the need to skew the line in situations where the line is under tension or load. Also, the method for release allows for the actuation to occur more expeditiously than with prior art constraints and in comparison with conventional fairleads, allows for the line to be released at any point along its length. The design may have dimensions which are scaled to provide use with different sizes or types of lines.

### SUMMARY OF THE INVENTION

One aspect of the present invention is a threadless fairlead assembly for receiving a line, comprising: a fairlead having a C-shaped body having a channel which provides a gap from the outside of the body to a fairlead aperture, said fairlead having dimensions permitting said line to pass laterally through said channel and locate in said fairlead aperture while permitting said line to be relatively parallel to the centerline of said aperture; said channel is defined by said base upper surface and a lower surface of top portion; and a pull pin oriented substantially vertical so as to provide the means to close and open said channel.

Another aspect is a threadless fairlead assembly for receiving a line, said assembly comprising at least one of either a double sided C-shaped body or a single C-shaped body, having a channel defined by a fairlead aperture, a lower surface of a top portion, and a base upper surface; a latch pin integral with a pull pin for capture of said line, said latch pin located within a latch pin cavity; and said latch pin oriented substantially vertical so as to provide a means to close and open said fairlead aperture to displace said latch pin relative to said latch pin cavity.

A third aspect of the present invention is a threadless fairlead assembly for receiving a line, consisting of: at least one C-shaped body having a channel which provides a gap from the outside of the body to a fairlead aperture, said fairlead having dimensions permitting said line to pass laterally through said channel and locate in said fairlead aperture while permitting said line to be relatively parallel to the centerline of said aperture; said channel is defined by said base upper surface and a lower surface of top portion; a pull pin integral with a latch pin oriented substantially vertical; and said latch pin can be disposed in an open position and a closed position.

### BRIEF DESCRIPTION OF THE DRAWINGS

FIG. 1 is a perspective view showing an embodiment of a threadless fairlead assembly of the present invention with both latch pins in closed position holding a line on a boat.

FIG. 2 is a perspective view showing an example of a prior art threadless fairlead.

FIG. 3 is a top view of an embodiment of a threadless fairlead assembly of the present invention with section line in parallel to the main face of the body and located in the middle of the body.

FIG. 4 is a section view of an assembly with section plane established in FIG. 3. The latch pin on the right is shown in the closed position and the latch pin on the left is in the open position.

FIG. 5 is a perspective view showing the threadless fairlead assembly of the present invention with latch pins in an open position 130, resting on the top of the body.

FIG. 6 is a perspective view of another embodiment of the present invention having a single C-shaped body.

### DETAILED DESCRIPTION

### Reference Numerals

10 threadless fairlead

11 double C-Shaped body

12 channel

14 aperture

17 spring

18 mounting hole

23 latch pin

39 pull pin

45 vertical cavity or latch pin cavity

55 latch pin centerline

56 base

62 aperture centerline

70 depression

80 pin face

90 angular direction

100 line or rope

110 biasing means

120 closed position

130 open position

140 base upper surface

150 top portion

160 lower surface of top portion

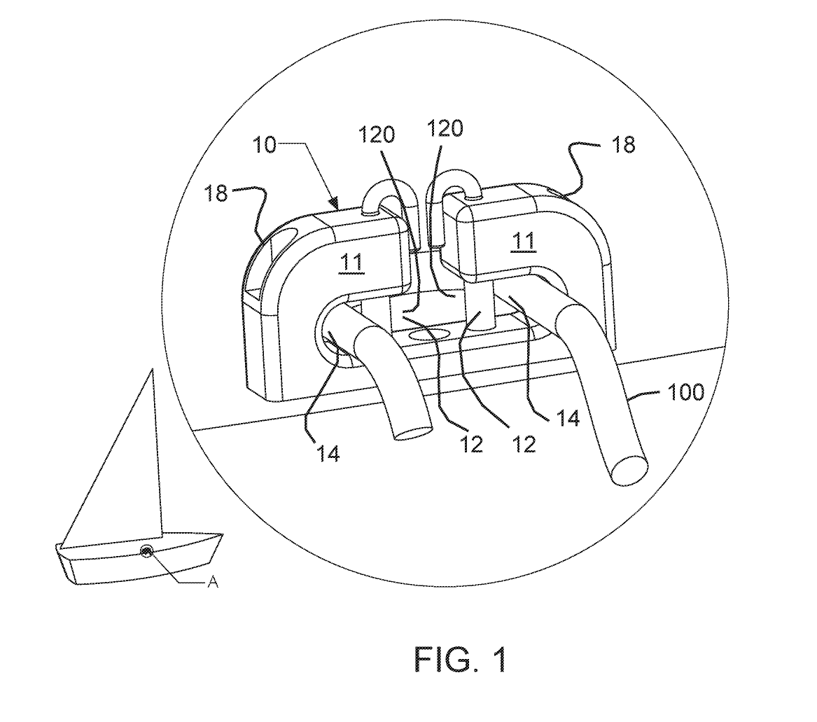

FIG. 1 illustrates one embodiment of the threadless fairlead of the present invention 10. A threadless fairlead 10 is illustrated on a boat, with a line 100 or rope 100 disposed in both apertures 14 and the latch pin 23 in the closed position. The latch pin 32 may be biased downwardly by a biasing means 110. In one embodiment the biasing means 110 may be a spring 17. In another embodiment the biasing means 110 may be a magnet.

The threadless fairlead 10 may have two opposed C-shaped bodies 11 which may define a channel 12, or two channels to receive a line 100. When the latch pin 23 is in the closed position 120 the line 100 may be disposed in the aperture 14. The channel 12 may be defined by the lower surface of top portion 160 and the base upper surface 140.

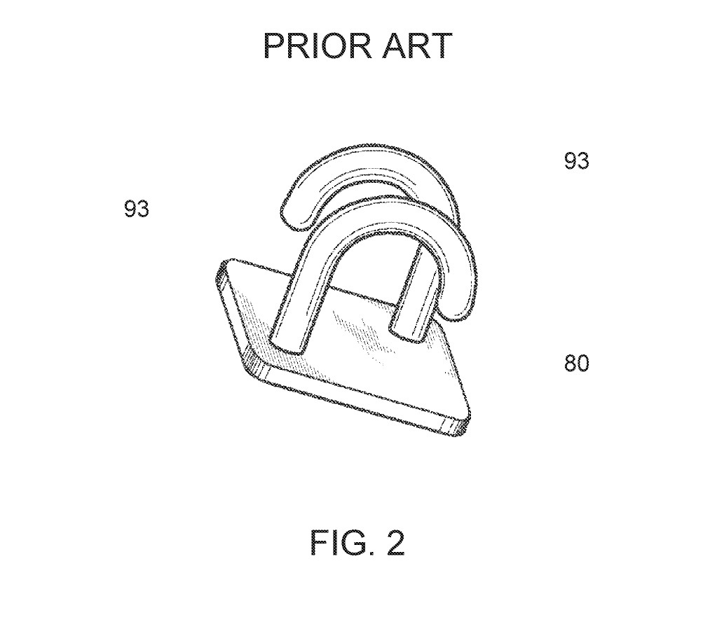

FIG. 2 illustrates an embodiment of a prior art fairlead.

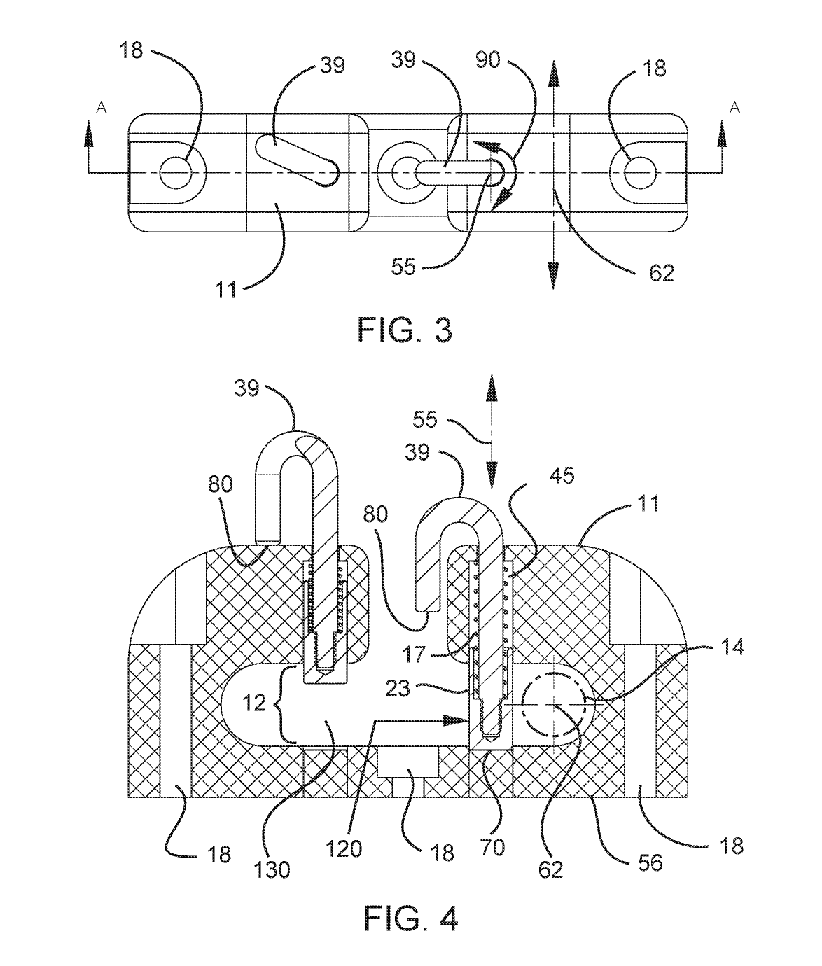

FIG. 3 illustrates an embodiment of a top view of the double C-shaped body 11. A pull pin 39 is illustrated in the closed position 120. The threadless fairlead 10 may have a mounting hole 18 to mount the threadless fairlead to a boat. An aperture centerline 62 is also illustrated. The latch pin centerline 55 is also illustrated, and may be offset from the aperture centerline 62. FIG. 3 also illustrates how the latch pin 23 may rotate in an angular direction 90.

FIG. 4 illustrates an embodiment of the present invention 10. The threadless fairlead 10 may have a double C-shaped body 11, made of two opposed C-shaped bodies. A right latch pin 23 is illustrated in the closed position 120. A left latch pin 23 is illustrated in the open position 130. The pull pin 39 may have a pin face 80 that may rest or be positioned on the top of the double C-shaped body 11 or top of the threadless fairlead 10 to maintain or position the latch pin 23 in the open position 130. The biasing means 110 may force or bias the latch pin 23 and thus the pull pin 30 downwardly. So when the pin face 80 is not placed against the top of the threadless fairlead 10 or top of the body 11, the latch pin 23 and pull pin 39 is pushed or biased downwardly in the closed position 120. The aperture centerlines 62 are disposed outwardly from the latch pin centerlines 55.

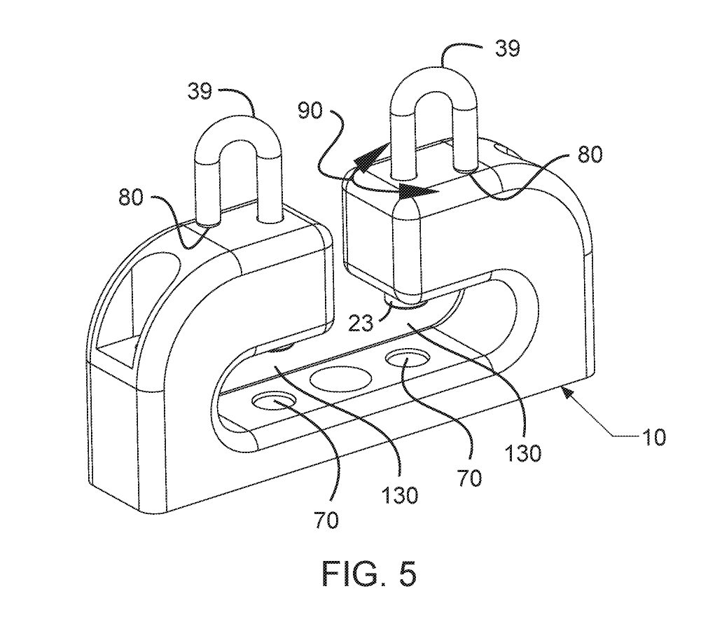

FIG. 5 illustrates another embodiment of the threadless fairlead 10 and the double C-shaped body 11. Both latch pins 23 and pull pins 39 are shown in the open position 130. FIG. 5 also illustrates an angular direction 90 by which the latch pin 23 may rotate. This allows the pin face 80 to be rotated 360 degrees and the pin face 80 may rest upon the top of the threadless fairlead 10 or top of the double C-shaped body 11. And the pull pin 39 may rotate so as to be displaced so the pin face 80 is not contacting the top of the threadless fairlead 10 or the double C-shaped body 11, or the single C-shaped body 111, and rotated or displaced so the pull pin 39 can be placed in the closed position 120.

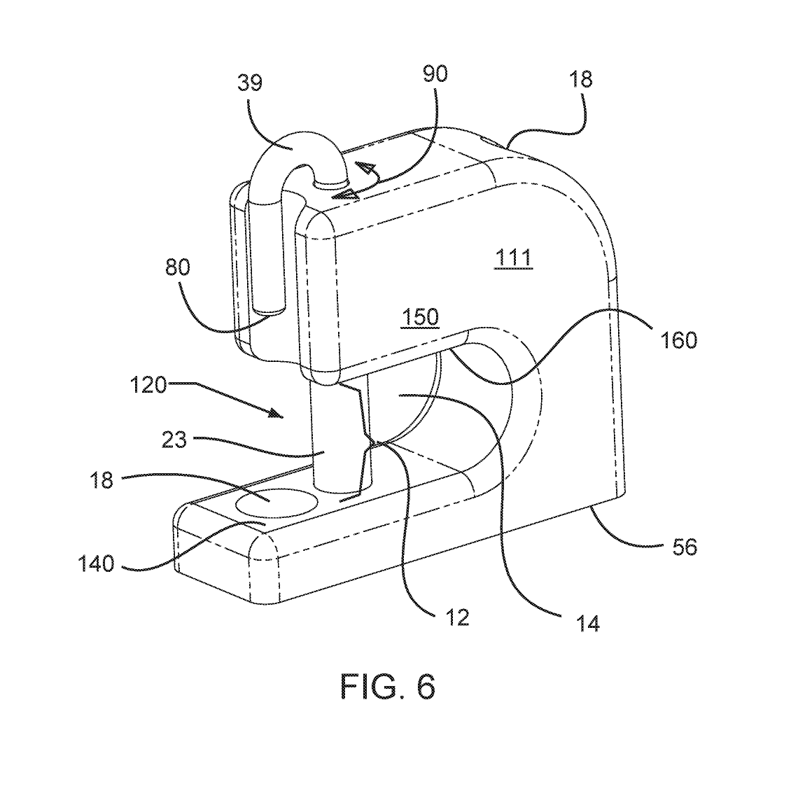

FIG. 6 illustrates another embodiment of the present invention 10 having a single aperture 14 and single C-shaped body 111. The pull pin 39 may be integrally connected or an extension of the latch pin 23. When the latch pin 23 is in the closed position 120. As illustrated and disclosed above for the previously disclosed threadless fairlead 10 having two opposed C-shaped bodies 11, the threadless fairlead 10 having a single C-shaped body 111 may have the same operable components. For example, the pin face 80 may be displaced upwardly and angularly displaced 90 so the pin face 80 can be disposed on the top of the threadless fairlead 10 or C-shaped body 111 to maintain the latch pin 23 in the open position 130 as in FIGS. 4 and 5. The C-shaped body 111 may have a mounting hole 18 disposed substantially vertically therein. A line 100 may be received and held in the aperture 14 when the latch pin 23 is in the closed position 120. The C-shaped body 111 defines a channel 12 between the base upper surface 140 and a top portion 150 lower surface 160.

FIGS. 1, 3, 4 & 5 and 6 Illustrate elements of the present invention and the combination of elements as an assembly. The assembly comprises a C-shaped body 111 or double C-shaped body 11, which may be provided with mounting holes 18 so as to be affixed securely to a part of the sailing vessel, such as a spar, deck or any other solid surface (not shown). The C-shaped body 111 or double C-shaped body may be oriented with a flat base 56, with the channel 12 parallel to this base 56 and open from the aperture 14 to the outside of the body 11. The channel 12 and aperture 14 have a width which is slightly larger than the largest diameter line that the fairlead can accept. The C-shaped body 111 or double C-shaped body may have a vertical cavity 45 which is perpendicular to the channel 12 and base 11, wherein, the latch pin 23 is located. The latch pin 23 moves within this cavity 45, the centerline 55 of which is offset from the centerline of the aperture 62. The distance from the centerline 55 of the latch pin 23 to the centerline 62 of the aperture 14 is established so that the line (as seen in FIG. 1) is able to be contained, and work, without restriction, in the aperture 14, as the latch pin 23 moves in and out of the channel 12. The latch pin 23 so provides the means to close and open the aperture 14. The latch pin 23 seats within a depression 70 in the bottom face of the channel 12 at closure of the aperture 14. This depression 70 is of the same diameter as the latch pin cavity 45 and provides for a locating surface to counter lateral forces that may be witnessed by the latch pin 23. If a lateral force is applied, the latch pin 23 acts upon the upper and lower portions of the body by its containment within the cavity 45 and lower depression 70. A pull pin 39 may be affixed to the top of the latch pin 23 and extends through the top of the body 11.

Alternatively the latch pin 23 and pull pin 39 may be one integral component or pin having a latch portion 23 and a pull portion 39.

The pull pin 39 is bent to conform to the shape of the body 11 and to prevent snagging with extraneous lines, rigging or other objects (not shown). The pull pin 39 moves in in unison with, or in direct relationship with the latch pin 23 and thusly provides the means to actuate the latch pin 23. The pull pin 39 may have a pin pace 80. The pull pin 23 and latch pin 23 may rotate in an angular direction 90, so the pin face 80 may rest on the top of the threadless fairlead 10 or double C-shaped body 11.

The latching mechanism can be forced to close with a spring 17 but could also be free or magnetically latched (not shown).

Use of the present invention 10 could generally be described wherein the sailor would lift the pull pin 39 and thusly the latch pin 23, opening the channel 12 to the aperture 14. The rope or line could then be pulled laterally through the open channel 12 and brought into the aperture 14. The sailor would then release the pull pin 39 and capture the line in the fairlead 10.

Release of the line from the fairlead 10 is generally where the pull pin 39 is used to lift the latch pin 23 clear of the channel 12. The line is then pulled laterally from the aperture 14 to the outside of the body 10 and the pull pin 39 is released. The orientation of the line in both the removal and engagement of the line is generally such that the latch pin centerline 55 can be parallel to the aperture centerline 62.

I claim:

1. A threadless fairlead assembly for receiving a line, consisting of:
a fairlead having a C-shaped body having a channel which provides a gap from the outside of the body to a fairlead aperture, said fairlead having dimensions permitting said line to pass laterally through said channel and locate in said fairlead aperture while permitting said line to be relatively parallel to the centerline of said aperture;
said channel (12) is defined by said base upper surface (140) and a lower surface of top portion (160); and
a pull pin (39) oriented substantially vertical so as to provide the means to close and open said channel (12).

2. The assembly of claim 1, wherein said channel can receive the line engageable by the fairlead.

3. The assembly as in claim 1, wherein the assembly comprises a base for securement to a surface.

4. The assembly as in claim 1, wherein the centerline of the said aperture is generally parallel to base.

5. The assembly as in claim 1, further comprising a latch pin (23) that rotates angularly 360 degrees, and said pull pin (39) has a pin face (80) that can be displaced so as to rest on a top of said threadless fairlead.

6. The assembly as in claim 5, wherein said channel is generally parallel to said base.

7. The assembly of claim 5, further comprising a biasing means (110) that biases said latch pin (23) downwardly.

8. A threadless fairlead assembly for receiving a line, said assembly comprising at least one of either a double sided C-shaped body (11) or a single C-shaped body (111), having a channel (12) defined by a fairlead aperture (14), a lower surface of a top portion (160), and a base upper surface (140);
a latch pin (23) integral with a pull pin (39) for capture of said line, said latch pin (23) located within a latch pin cavity (45); and
said latch pin (23) oriented substantially vertical so as to provide a means to close and open said fairlead aperture (14) to displace said latch pin (23) relative to said latch pin cavity (45).

9. The assembly as in claim 8, wherein a biasing means (100) is operably connected to said latch pin (23) to impose a downward force on said latch pin (23).

10. The assembly as in claim 8, wherein said latch pin (23) rotates in an angular direction (90) and a pin face (80) can be disposed on top of at least one of either said threadless fairlead (10) or said double sided C-shaped body (11).

11. The assembly as in claim 8, wherein centerline of said latch pin is offset from centerline of said aperture.

12. The assembly as in claim 8, wherein said latch pin locates in a depression in the bottom of said channel.

13. The assembly as in claim 10, wherein said channel (12) and an aperture (14) have a width which is slightly larger than the largest diameter line that the fairlead can accept.

14. The assembly as in claim 8, wherein the latch pin (23) can be maintained in an open position (130)) or a closed position (120) so as to allow for the extraction or insertion of said line, said line being able to generally maintain parallelism with an aperture centerline, as said line moves in and out of said fairlead assembly.

15. A threadless fairlead assembly for receiving a line, consisting essentially of:
at least one C-shaped body having a channel (12) which provides a gap from the outside of the body to a fairlead aperture, said fairlead having dimensions permitting said line to pass laterally through said channel and locate in said fairlead aperture while permitting said line to be relatively parallel to the centerline of said aperture;
said channel (12) is defined by said base upper surface (140) and a lower surface of top portion (160); and
a pull pin (39) integral with a latch pin (29) oriented substantially vertical; and
said latch pin (29) can be disposed in an open position 130 and a closed position 120.

16. The apparatus of claim 15 wherein said latch pin (23) rotates in an angular direction (90).

17. The apparatus of claim 15, further comprising a biasing means (110) that biases said latch pin (23) downwardly.

18. The apparatus of claim 15, further comprising a mounting hole (18) to receive a fastener to mount the threadless fairlead to an object.
